(19) United States
(12) Patent Application Publication
(10) Pub. No.: US 2026/0227215 A1
(43) Pub. Date: Aug. 6, 2026

(54) INSERT FOR A HOUSING OF A SENSOR

(71) Applicant: Pepperl + Fuchs SE, Mannheim (DE)

(72) Inventor: Stephan M. TEMME, Ludwigshafen (DE)

(73) Assignee: Pepperl + Fuchs SE, Mannheim (DE)

(21) Appl. No.: 19/152,794

(22) PCT Filed: Jan. 23, 2024
(86) PCT No.: PCT/EP2024/051512

§ 371 Date: Jul. 31, 2025

(30) Foreign Application Priority Data
Feb. 2, 2023 (DE) 10 2023 102 569.4

(51) Int. Cl. G01D 11/30; F16B 5/02; G01D 11/24

(52) U.S. Cl. CPC G01D 11/30; F16B 5/0241; G01D 11/245

(57) ABSTRACT

An insert (10) for a housing (2) of a sensor (1) includes an outer portion (27) and an inner portion (28). A deformable element (29) is arranged between the inner portion (28) and the outer portion (27).

### CROSS-REFERENCE TO RELATED APPLICATION

This application is a national stage application, filed under 35 U.S.C. § 371, of International Patent Application PCT/EP2024/051512, filed on Jan. 23, 2024, which claims the benefit of German Patent Application DE 10 2023 102 569.4, filed on Feb. 2, 2023.

### TECHNICAL FIELD

The disclosure relates to an insert part for a sensor housing of a sensor.

### BACKGROUND

A sensor is a technical component, with which specific physical or chemical characteristics can be detected. It is also possible to quantitatively and qualitatively detect the physical properties of the surroundings with a sensor. Such a sensor is usually located in a housing and is fastened to a mounting surface of an apparatus, for example to a mounting surface of an industrial installation, by means of fasteners.

A sensor is frequently subjected to undesired vibration frequencies, which can affect the measurements, which can then lead to the measurement results being falsified. In order to avoid this, buffer elements, for example buffer sleeves, can be provided which absorb these vibrations.

As a sensor can also be subjected to shocks, it is necessary to also absorb these because vibrations and shocks which affect the sensor can ultimately damage the sensor housing and thus also the sensor.

### SUMMARY

An object of the present disclosure is to provide an apparatus with which excessive accelerations, in particular shocks and vibrations, can be absorbed, so that the sensor housing is not damaged.

This object is solved by an apparatus as disclosed and claimed.

Thus, an insert part for a sensor housing of a sensor is described as an apparatus, wherein the insert part has an outer section and an inner section, between which a deformable element is arranged.

Preferably, the inner section and the outer section are designed as sleeves because sleeves are simple and economical components. These sleeves can be cylindrical, for example.

If the inner section and the outer section are designed as sleeves, the inner section is present as an inner sleeve and the outer section is present as an outer sleeve, wherein the deformable element is located between the outer sleeve and the inner sleeve. It is also conceivable that the outer section is cuboidal and thus the insert part has a cuboid basic shape. In this case, the sections would be sleeves which are substantially square in design.

For the sake of simplicity, in the following only an outer sleeve and an inner sleeve are discussed, between which the deformable element is arranged, wherein the deformable element can similarly have the shape of a sleeve. This insert part can be easily inserted into the housing by thermal embedding. If the sensor is to be fastened on a mounting surface of an installation, this can be done by means of fasteners, such as screws, for example. These fasteners (also called connecting means in the following) are guided through corresponding feed-throughs of the insert parts and are fastened to the mounting surface. As the fasteners are guided through openings (also referred to as feed-throughs in the following) of the insert parts, mechanical shocks or undesired vibrations no longer have any effect on the measurements performed by a sensor because shocks and vibrations are absorbed by the insert parts. The insert parts thus act as vibration and shock absorbers. Due to the presence of the deformable element, the system rigidity is thus reduced, meaning that the maximum impulse force can remain below the component rigidity of the housing to be protected.

It should be emphasized again here that the shape of the outer section and of the inner section does not play any role because only the deformable element which is arranged between the two sections is responsible for absorbing shocks and undesired vibrations.

Advantageously, the outer sleeve and the inner sleeve consist of a metal or a metal alloy, such as steel or brass. Thus, these are metal sleeves, between which the deformable element is arranged. This deformable element preferably consists of a thermoset material, an elastomer or a thermoplastic. As the outer sleeve consists of a metal or a metal alloy, the insert part can be easily inserted into the sensor housing by thermal embedding. To this end, the sensor housing has an opening, into which the insert part has been inserted beforehand. In this case, it is advantageous that a thread for directly screwing in a connecting means is arranged in the inner sleeve. The outer sleeve and the inner sleeve therefore adopt the function of a metal insert. The fact that the deformable element is arranged between the outer sleeve and inner sleeve means that mechanical shocks and undesired vibrations can be absorbed, whereby the deformable element adopts the task of a buffer. Because the insert part adopts two functions, specifically that of a metal insert and that of a buffer, the number of components is reduced because only one component has to be used instead of a buffer sleeve and a metal insert. This not only leads to a reduction in the number of components, but also saves space because there is no longer a need to install two different components at different places on the sensor housing. As the buffer sleeves can be glued in the case of known sensor housings, there is also the danger of the adhesive connection releasing and the buffer sleeves falling out of the sensor housing. This danger no longer exists with the insert part because it is inserted into the sensor housing such that it is held captive with a form fit. Because the insert part also has the function of a metal insert, the retardation of the material of the sensor housing is reduced to a minimum.

Preferably, the inner sleeve has a thread for screwing in a connecting means. Therefore, it is possible to fasten the sensor securely to the mounting surface.

Preferably, the outer sleeve has an outer contour. Therefore, it is guaranteed that the insert part is arranged more securely in the sensor housing after the thermal embedding than would be the case if the outer sleeve did not have an outer contour, i.e. if the outer sleeve had a smooth outer surface.

Furthermore, a sensor having at least one insert part is described, wherein the at least one insert part is inserted into an opening of a wall section of the sensor housing. Advantageously, however, this wall section has more than only one opening into which an insert part can be inserted, because then the sensor can be attached more firmly and securely to a mounting surface of an installation. Preferably, these openings are provided in the bottom of the sensor housing, wherein particularly preferably four openings are provided in the bottom, whereby four insert parts can be inserted into the bottom.

On a bottom side of the bottom, at least one support structure is arranged, whereby the sensor lies on a mounting surface of an installation. This at least one support structure consists of a substantially flexible material and the geometry-structural rigidity combination is so pliable that the support structure can deform when the sensor is subjected to strong vibrations or shocks, for example.

The invention also relates to an arrangement consisting of the sensor having at least one insert part and a mounting surface of an installation, on which the sensor is fastened to the mounting surface via at least one connecting means.

### BRIEF DESCRIPTION OF THE DRAWINGS

Exemplary embodiments of the invention are described in more detail in the following using the figures.

FIG. 1 shows a perspective view of a sensor;

FIG. 2 shows a bottom side of the sensor shown in FIG. 1;

FIG. 3 shows a side view of the sensor shown in FIG. 1, which is attached to a mounting surface of an installation;

FIG. 4 shows the sensor shown in FIG. 3 and the mounting surface to which the sensor is fastened, wherein a section A-A has been made through the sensor and the mounting surface;

FIG. 5 shows an excerpt of the sensor shown in FIG. 4 and the mounting surface to which the sensor is attached;

FIG. 6 shows a side view of a first variation of an insert part;

FIG. 7 shows a plan view of the first variation of an insert part, and

FIG. 8 shows a plan view of a further variation of an insert part.

### DETAILED DESCRIPTION

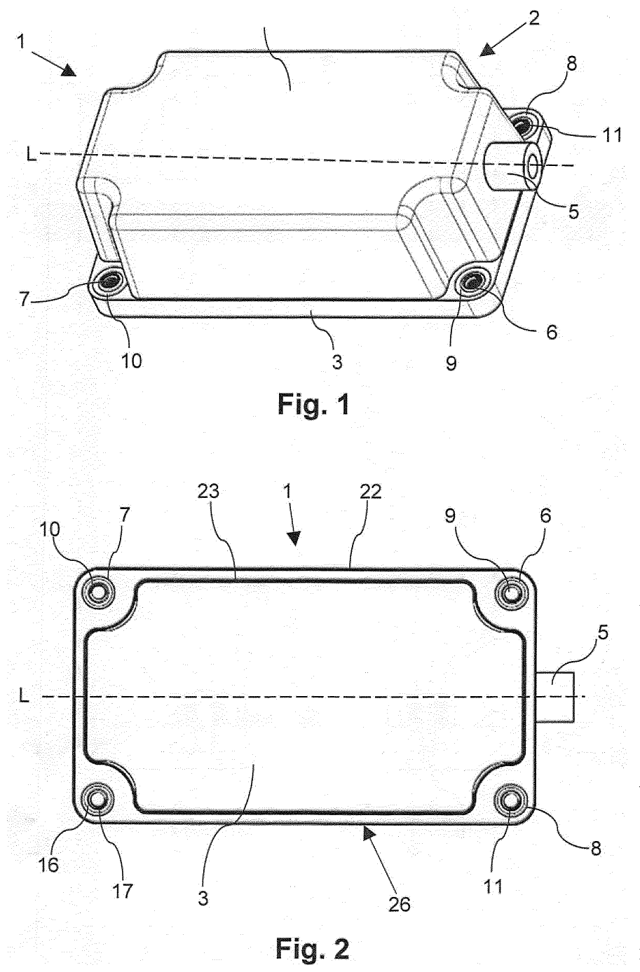

FIG. 1 shows a perspective view of a sensor 1 which is located in a sensor housing 2. In this exemplary embodiment, the sensor housing 2 consists of two parts, specifically a lower section 3, designed as a bottom 3, and a cover 4, wherein the cover 4 forms an upper section 4. A connection cable 5 is arranged on the upper section 4. As such an arrangement consisting of a sensor having a sensor housing 2 and a connection cable 5 is known, a description of this arrangement in more detail has been omitted. The sensor housing 2 can consist of plastic (for example a thermoset material, elastomer or thermoplastic) or of metal with a low strength value or metal with a high strength value, but with low deformation capacity. For example, die-cast zinc alloy is suitable as a metal.

So that the sensor 1 can be fastened to a mounting surface of an installation, for example an industrial installation, several openings are provided, through which the fasteners which can be used to fasten the sensor 1 to the corresponding mounting surface can be guided. Fasteners and a mounting surface are not shown in FIG. 1.

The openings are all located in the bottom 3, with only the openings 6, 7 and 8 being visible in FIG. 1. The fourth opening cannot be seen due to this view. The bottom 3 thereby forms a mounting plate of the sensor 1. It is understood that more or fewer openings can also be provided.

In each case, an insert part 9 to 11 is arranged in each of the openings 6 to 8. A feed-through for inserting a fastener is arranged in each insert part 9 to 11. However, for the sake of clarity, the feed-throughs are not provided with reference signs in FIG. 1.

It is understood that, in general, the bottom 3 can also be referred to as a wall or as a wall section and that it is possible that such openings are also been made in other wall sections of the sensor housing 2. However, as a sensor is connected to a mounting surface mostly only via one surface, in this exemplary embodiment the bottom 3 is the wall section with which the sensor 1 is connected to the mounting surface. In this case, it is also conceivable that the corresponding wall section has more or less than only four openings for inserting insert parts. However, at least one opening has to be provided so that the sensor 1 can be fastened to a mounting surface.

FIG. 2 shows a bottom side 26 of the sensor 1 shown in FIG. 1 after rotating 180° about a longitudinal axis L, so that it is facing the bottom 3. In this view, all openings 6, 7, 8, 16 made in the bottom 3 can be seen, in which in each case one insert part 9, 10, 11, 17 is inserted. Connecting means, such as screws for example, can be inserted into these insert parts 9, 10, 11, 17. A first outer support structure 22 and a second inner support structure 23 is arranged on the bottom 3, wherein the two support structures 22, 23 run substantially parallel to each other and are designed as carrier frames. With these two support structures 22, 23, the sensor 1 lies on a mounting surface of an installation when this sensor 1 is fastened to the mounting surface. The two support structures 22, 23 thus form contact surfaces for the mounting surface of the corresponding installation. These support structures 22, 23 consist of a substantially flexible material and are so pliable that the support structures 22, 23 can deform when the sensor 1 is subjected to strong vibrations or shocks, for example. In a region 24 between the support structure 22 and the support structure 23, there is a compressible medium (for example air) or a nitrogen-filled and thus compressible foam material.

Although only two support structures 22, 23 are arranged on the bottom 3 of the sensor 1, it is also conceivable that only one support structure or more than two support structures are provided, if necessary. More than two support structures can be useful for example, when it is foreseeable that the sensor will be subject to strong shaking or vibrations or mechanical shocks. Under some circumstances, it can also be sufficient to provide only one support structure, for example when the sensor is very small, or when the support structure has a complex contour.

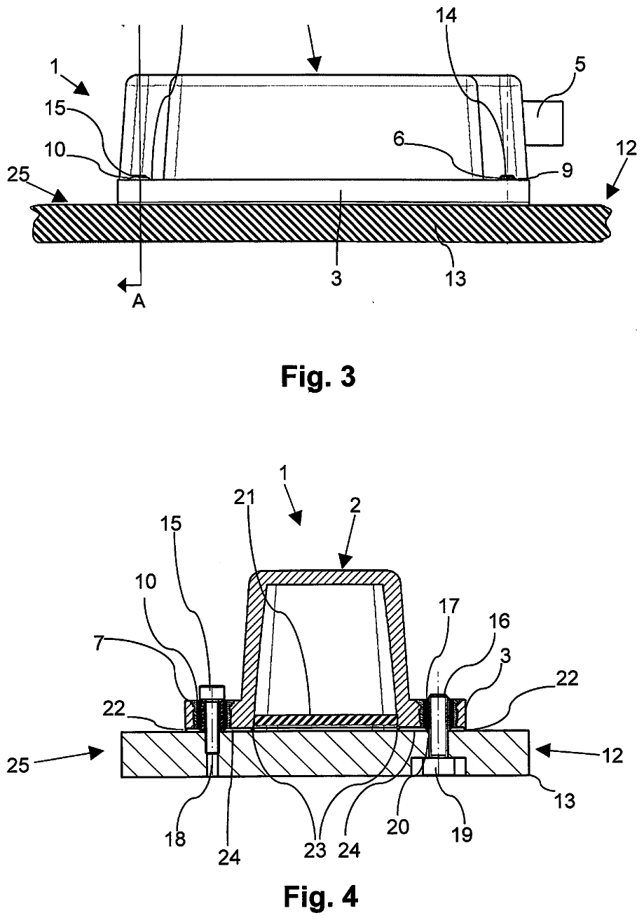

FIG. 3 shows the sensor 1, which lies with the bottom 3 on a mounting surface 13 of an installation 12 and is fastened to this mounting surface 13 by means of fasteners, for example screws.

In FIG. 3, the two insert parts 9, 10 which are inserted into the corresponding opening 6 or 7 of the bottom 3 can at least partially be seen. A fastener 14 is inserted into the insert part 9 and a fastener 15 is inserted into the insert part 10. The sensor 1 is fastened to the mounting surface 13 of the installation 12 with these fasteners 14, 15. The sensor 1 and the mounting surface together form an arrangement 25.

FIG. 4 shows the sensor 1 attached to the mounting surface 13 after a section A-A has been made through the arrangement 25 shown in FIG. 3 consisting of the sensor 1 and the mounting surface 13 of the installation 12. Not only can the feed-through 7 having the insert part 10 arranged therein be seen in this view, but also the fourth feed-through 16 having an insert part 17 arranged therein. On the sensor side, the connecting means 15 is introduced through the insert part 10, wherein the connecting means 15 engages at least partially also into a feed-through 18 of the mounting surface 13, whereby the connecting means 15 connects the sensor 1 at this point securely to the mounting surface 13.

A connecting means 19 engages into the insert part 17, wherein the connecting means 19 is attached on the installation side. The connecting means 19 is therefore guided through the opening 20 of the mounting surface 13 and finally engages into the insert part 17. At this point, the sensor 1 is thus connected to the installation 12 via the connecting means 19.

Thus, it is clear to a person skilled in the art that it makes no difference whether the connecting means, with which the sensor 1 is fastened to the installation 12, are inserted on the structure side or sensor side.

Although the interior of the sensor 1 is not represented, an inner housing bottom plate 21 can be seen which is part of the bottom 3. The two support structures 22, 23 consisting of pliable material are arranged on the bottom 3, between which support structures the region 24 filled with air is located. Owing to the two support structures 22, 23 it is ensured that the bottom 3 is not directly in contact with the mounting surface 13. If the sensor 1 is subject to undesired vibrations or shocks, the two support structures 22, 23 can bend or buckle to the side and thus release the movement of the housing in the direction of the mounting surface 13.

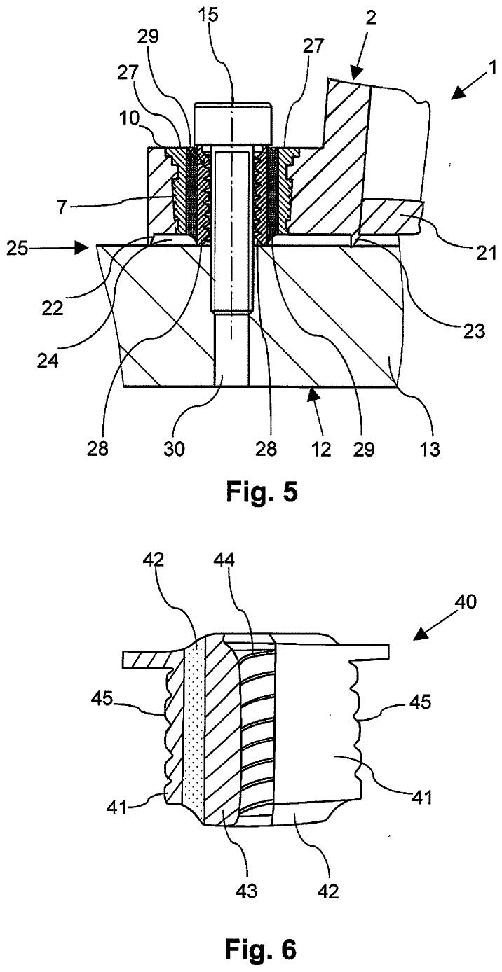

FIG. 5 shows a section of the sensor 1 shown in FIG. 4, which is fastened to the mounting surface 13. Shown in this case is that section of the arrangement 25 at which the sensor 1 is connected to the mounting surface 13 via the connecting means 15. The connecting means 15 is guided on the sensor side through the insert part 10, wherein the insert part 10 sits firmly in the opening 7 of the sensor housing 2 due to the thermal embedding process. The insert part 10 comprises an outer section 27 and an inner section 28, wherein a deformable element 29 is arranged between the outer section 27 and the inner section 28. The element 29 consists of a plastic, preferably a thermoset material, an elastomer or a thermoplastic. The two sections 27, 28 consist of a metal or a metal alloy, wherein the two sections 27, 28, for example, can consist of steel or brass. The outer section 27 has an outer contour (without reference sign), through which it is ensued that the insert part is arranged more firmly in the sensor housing after the thermal embedding than would be the case if the outer sleeve did not have an outer contour. The inner section 28 has a thread as an inner contour (without reference sign). Therefore, it is possible to insert connecting means 15 firmly into the insert part 10 and to ensure a firm connection between the sensor 1 and the mounting surface 13. To this end, the connecting means 15 is also inserted at least partially into an opening 30 of the mounting surface 13, wherein the opening 30 is also equipped with a thread, which however is not represented in FIG. 5.

The sensor 1 is in contact with the mounting surface 13 on this section only with the two support structures 22, 23 of the sensor housing 2 and with the inner section 28 of the insert part 10. Otherwise, the bottom 3 of the sensor housing 2 is spaced apart from the mounting surface 13. It is also possible that the inner section 28 of the insert part 10 is not in contact with the mounting surface 13.

If the sensor 1 is subject to undesired vibrations or shocks, the two support structures 22, 23 can bend or buckle to the side and thus release the displacement of the sensor housing 2 in the direction of the mounting surface 13. Due to the movement of the sensor housing 2, the deformable element 29 is also deformed in the insert part 10. As the element 29 can be deformed, the movement energy is not transmitted to the inner section 28 and thus also not to the connecting means 15. This prevents the fastener 15 from being released or even broken, i.e. destroyed, by the force applied. Therefore, shocks and vibrations do not have any effect on the connection between the sensor 1 and the mounting surface 13.

This insert part 10, similarly to the insert parts 9, 11, 17 of the sensor 1 (compare FIG. 2), can therefore for example have the shape of a cuboid open in the centre or also the shape of a cylindrical sleeve.

In FIG. 6, a side view of a first variation of the insert part shown in FIG. 5 without being arranged in a sensor housing-is represented. So that the interior of the insert part 40, represented in FIG. 6, can also be seen, a part of the insert part 40 has been cut out. This insert part 40 also has an outer section 41, a deformable element 42 adjoining the latter and an inner section 43 adjoining the element 42. An inner contour 44 of the inner section 43, designed as a thread, can be seen. The outer section 41 has an outer contour 45, which differs from the structure of the insert part 10, but it has the same function. A feed-through 46 for a fastener (not shown) is located in a centre of the insert part 40.

The insert part 40 is designed as a cylindrical sleeve. In this case too, the two sections 41, 43 consist of a metal or a metal alloy and the element 42 consists of plastic, so that here as well, the element 43 serves to absorb the energy from shocks or undesired vibrations and to not pass this energy to the inner section 43. As the two sections 41, 43 consist of metal or a metal alloy, the deformable element 42 is surrounded by two cylindrical metal sleeves, wherein the element 42 consisting of plastic is similarly designed as a cylindrical sleeve and thus forms a cylindrical plastic sleeve.

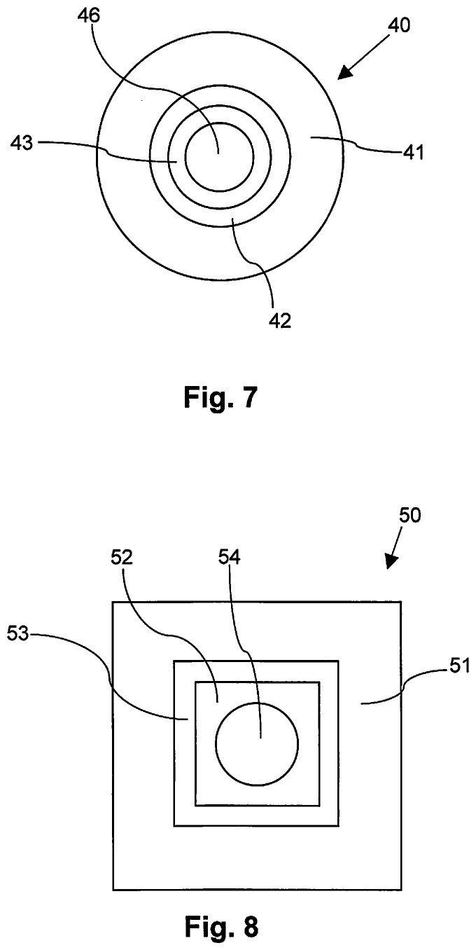

FIG. 7 shows a plan view of the insert part 40. The deformable element 42 is arranged between the outer section 41 and the inner section 43. The feed-through 46 through which the fastener can be guided is arranged in the centre of the insert part 40.

FIG. 8 shows a plan view of a further variation of an insert part 50. This insert part 50 has a substantially cuboidal construction and in turn has three sections, specifically an outer section 51 and an inner section 52, wherein the two sections 51, 52 surround a deformable element 53 designed as a central section 53. The insert part 50 has in a centre a feed-through 54 into which a connecting means (not shown) can be inserted. The two sections 51, 52 consist of a metal or a metal alloy and the central section 53 consists of plastic, so that the basic construction of the insert parts 9, 10, 11, 17, 40 and 50 is identical and these insert parts 9, 10, 11, 17, 40 and 50 only differ in terms of their shape (for example, cuboidal or cylindrical), the outer contour and the inner contour. However, each of these insert parts 9, 10, 11, 17, 40 and 50 has a deformable element, which is arranged between an outer section and an inner section, wherein the deformable element can absorb the energy from shocks or undesired vibrations.

### REFERENCE SIGN LIST

1 sensor
2 sensor housing
3 lower section designed as a bottom
4 cover
5 connection cable
6 to 8 openings
8 to 11 insert parts
12 installation
13 mounting surface
14 fastener
15 connecting means
16 opening
17 insert part
18 opening
19 connecting means
20 opening
21 housing bottom plate
22 outer support structure
23 inner support structure
24 intermediate region
25 arrangement
26 bottom side
27 outer section
28 inner section
29 deformable element
30 opening
40 insert part
41 outer section
42 deformable element
43 inner section
44 inner contour
45 outer contour
46 feed-through
50 insert part
51 outer section
52 inner section
53 deformable element
54 feed-through

1.-10. (canceled)

11. An insert part (8 to 11, 17, 40, 50) for a sensor housing (2) of a sensor (1), comprising:
an outer section (27, 41, 51);
an inner section (28, 43, 52); and
a deformable element (29, 42, 53) arranged between the inner section (28, 43, 52) and the outer section (27, 41, 51).

12. The insert part according to claim 11,
wherein the outer section (27, 41, 51) and the inner section (28, 43, 52) consist of metal or a metal alloy, and
wherein the deformable element (29, 42, 53) consists of plastic.

13. The insert part according to claim 11,
wherein the inner section (43) has an inner contour designed as a thread for screwing in a fastener.

14. The insert part according to claim 11,
wherein the outer section (41) has an outer contour (45).

15. The insert part according to claim 11,
wherein the outer section (41) and the inner section (43) are cylindrical sleeves, and
wherein the deformable element (42) is arranged between the cylindrical sleeves.

16. The insert part according to claim 15,
wherein the outer section (41) forms an outer cylindrical metal sleeve, and
wherein the inner section (43) forms an inner cylindrical metal sleeve.

17. A sensor, comprising:
a sensor housing (2); and
the insert part according to claim 11,
wherein the insert part (8 to 11, 17, 40, 50) is inserted into a feed-through (6 to 8, 16) of a wall section (3) of the sensor housing (2).

18. A sensor, comprising:
a sensor housing (2) having a wall section (3) at a bottom (3) of the sensor housing (2); and
a plurality of insert parts according to claim 11,
wherein the bottom (3) has more than one feed-through (6 to 8, 16), and
wherein one of the plurality of insert parts (8 to 11, 17) is arranged in each feed-through (6 to 8, 16).

19. The sensor according to claim 18,
wherein at least one support structure (22, 23) is arranged on a bottom side (26) of the bottom (3), whereby the sensor (1) can be arranged on a mounting surface (13) of an installation (12).

20. An arrangement (25) comprising:
the sensor (1) according to claim 17; and
a mounting surface (13) of an installation (12),
wherein the sensor (1) is connected to the mounting surface (13) via at least one fastener (14, 15, 19).
